(19) United States
(12) Patent Application Publication
(10) Pub. No.: US 2007/0192349 A1
(43) Pub. Date: Aug. 16, 2007

(54) Data provisoning method and system

(76) Inventors: Jeffrey R. Farr, Ipswich (GB); Ben Strulo, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/591,348

(22) PCT Filed: Feb. 18, 2005
(86) PCT No.: PCT/GB05/00586

§ 371 Date: Aug. 31, 2006

(30) Foreign Application Priority Data
Mar. 8, 2004 (GB) 0405187.6
Jun. 17, 2004 (GB) 0413622.2

(51) Int. Cl. G06F 7/00

(52) U.S. Cl. 707/102

(57) ABSTRACT

Data items or data defining access to data items for provision to one or more users and respective service level data usable to determine a level of service to be provided to the respective users is maintained. Data items or data defining access to data items is received from users for provision to users and rating data is received from one or more users relating to data items provided to those users. Respective service level data for those users from which data items or data defining access to data items were received is changed in dependence upon received rating data relating to those received data items or data defining access to data items. Service is provided to a user in dependence on the service level data for that user.

### TECHNICAL FIELD

The present invention relates to a data provisioning method and system for providing data such as content items to users. In particular the level of service given to a user in response to a request for data is dependent upon user reviews of data items which the user herself makes available to other users.

### BACKGROUND TO THE INVENTION AND PRIOR ART

The widespread use of internet-based technologies has made available more data to more users than ever before. Moreover, the capability of individual users to provide data which is then accessible via the internet to many other users is also a further effect of the widespread use of the internet. Such user provided data need not only be by way of a user providing and maintaining her own web page or the like, but may also be provided by users providing data to existing websites, newsgroups, bulletin boards or the like, which data may then be accessed by other users. Such data provision systems are a form of peer to peer (P2P) system.

It is possible to identify three general classes of P2P systems:

i) where service is provided by individual peers, and is generally consumed by other peers such that service provision and remuneration is inherently pairwise. Prior art examples of such peer to peer services are Gnutella (see www.gnutella.com) and Kazaa (see www.kazaa.com).

ii) where service is provided by a group of peers (eg fragmented file downloads); and

iii) another in which service is effectively provided by the entire group of peers (‘emergent service provision’, ESP), and is, potentially, effectively consumed by all peers. Examples of such systems are newsgroups, review websites, bulletin boards or the like.

Within the first and second classes of P2P network mentioned above the problem has been identified that some peers provide a great many of the data items available for download, whilst the majority of users share little or no files. Vishnumurthy et al in Karma: A Secure Economic Framework for Peer-to Peer Resource Sharing Procs Workshop on the Economics of Peer-to-Peer Systems, Berkeley, Calif., June 2003 report that 20 to 40% of Napster and almost 70% of Gnutella peers share little or no files, and comment that this is unsurprising as there is little incentive for peers to contribute resources. Vishnumurthey et al further describe a proposed framework to address this problem, where each peer has single scalar value referred to as Karma, which is increased as resources are contributed, and decreased when resources are consumed. In order to be able to download a file, therefore, the peer must have sufficient Karma in its “account” to be able to afford the download.

A similar system addressing the same problem is described by Gupta et al in A Frequent-Sharer Program for Peer-to-Peer Systems, downloadable from http://www.cc.gatech.edu/grads/g/Minaxi.Gupta/pubs/tr-incentives.Ddf. Here, peers earn points as they serve data, and a peer is subsequently provided a level of service (LoS) based on the number of points she earns in the system. In order to ensure that peers continue to serve content even after earning points and becoming eligible for an enhanced level of service, points earned by a peer expire periodically. Hence, peers have to keep contributing to the system in order to retain or upgrade their LoS.

However, the same problem of encouraging contributions also exists in the ESP P2P system, such as a newsgroup. Generally newsgroups function by members posting newsworthy information, or by asking a question and having others respond to that question. The economic structure is therefore that peers make contributions to the community, and all members of the community then receive benefit. A strong characteristic is that the inherent cost of contributing is very high, whilst the cost of consumption is minimal. Even the cost of repeated acts of consumption is minimal.

Typically, the real utility of such an application (to end users) generally comes from the combination of the initial question, and public answers to that question—ie it is an emergent property, with service effectively provided by the entire group of peers. Many members of the community (potentially, at least) receive benefit from the discussion. As mentioned previously, there are many similar situations with this characteristic, especially those in which the contribution is human-generated content (which inherently has very high costs), such as websites which provide user reviews.

The present invention aims to address the above described problem of incentivising contributions particularly, although not exclusively, in peer to peer systems with emergent service provision attributes.

### SUMMARY OF THE INVENTION

The present invention addresses the problem outlined above by providing a data provision method and system which maintains, for each user, service level data which defines the level of service which a user will receive in response to a request made by him for service of data items. To incentivise good quality contributions of data the service level data is changed in dependence upon peer review values assigned to content or data items made available by a user to the other users. By relying on peer review values to change the level of service received by a user, it is possible to prevent a user from artificially raising his service level by providing many low-quality or useless data items. The invention is suitable for implementation in a distributed manner using peer to peer technology, or in a centralised manner using a traditional client server architecture.

Aspects of the invention will be apparent from the appended claims.

### DESCRIPTION OF THE DRAWINGS

Further features and advantages of the present invention will become apparent from the following description of embodiments thereof, presented by way of example only, and by reference to the accompanying drawings, wherein like reference numerals refer to like parts, and wherein:

FIG. 1 illustrates a general purpose computer system which may be used in embodiments of the present invention;

FIG. 2 is a block diagram of components of the general purpose computer system of FIG. 1;

FIG. 3 is a system block diagram illustrating a first embodiment of the present invention;

FIG. 4 is a flow diagram illustrating part of the operation of the first embodiment of the present invention;

FIG. 5 is a flow diagram illustrating part of the operation of the first embodiment of the present invention;

FIG. 6 is a flow diagram illustrating part of the operation of the first embodiment of the present invention;

FIG. 7 is a diagram illustrating elements and message flows of a second embodiment of the present invention;

FIG. 8 is flow diagram illustrating the operation of part of the second embodiment of the present invention;

FIG. 9 is a flow diagram illustrating the operation of part of the second embodiment of the present invention;

FIG. 10 is a diagram illustrating message flows between elements within the second embodiment of the present invention;

FIG. 11 is a diagram illustrating message flows between elements within a second embodiment of the present invention;

FIG. 12 is a flow diagram illustrating part of the operation of the second embodiment of the present invention;

FIG. 13 is a flow diagram illustrating part of the operation of the second embodiment of the present invention;

FIG. 14 is a flow diagram illustrating part of the operation of the second embodiment of the present invention; and

FIG. 15 is a flow diagram illustrating part of the operation of the second embodiment of the present invention.

### Description of the Embodiments

Various embodiments of the invention will now be described. The embodiments of the invention to be described are primarily software based, using appropriate computer programs stored on and executed by computer systems. The individual computer systems used in the embodiments of the invention may perform different functions depending on the architecture of the particular embodiment. For example, some embodiments of the invention are based upon a client server architecture, wherein one of the computer systems functions as a server, and other of the computer systems function as clients, being served by the server. Other embodiments of the invention may use a peer to peer architecture, wherein each computer system performing the invention is a peer of every other, and may perform at least one or more functions in accordance with the embodiments of the invention for various others of its peers. Whichever architecture is adopted for a particular embodiment, it should be understood that the basic operating principles to allow communications between different computer systems are those known already in the art, whether client-server or peer-to-peer based.

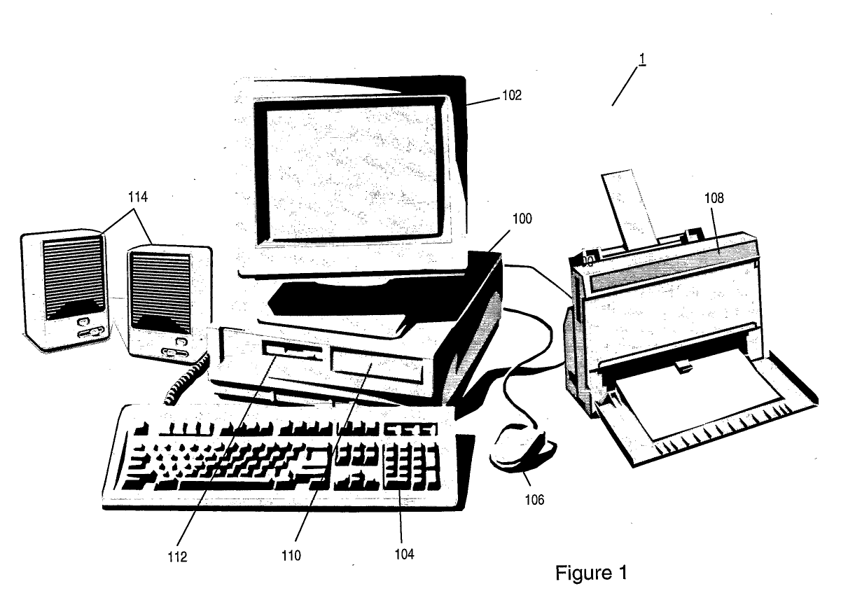

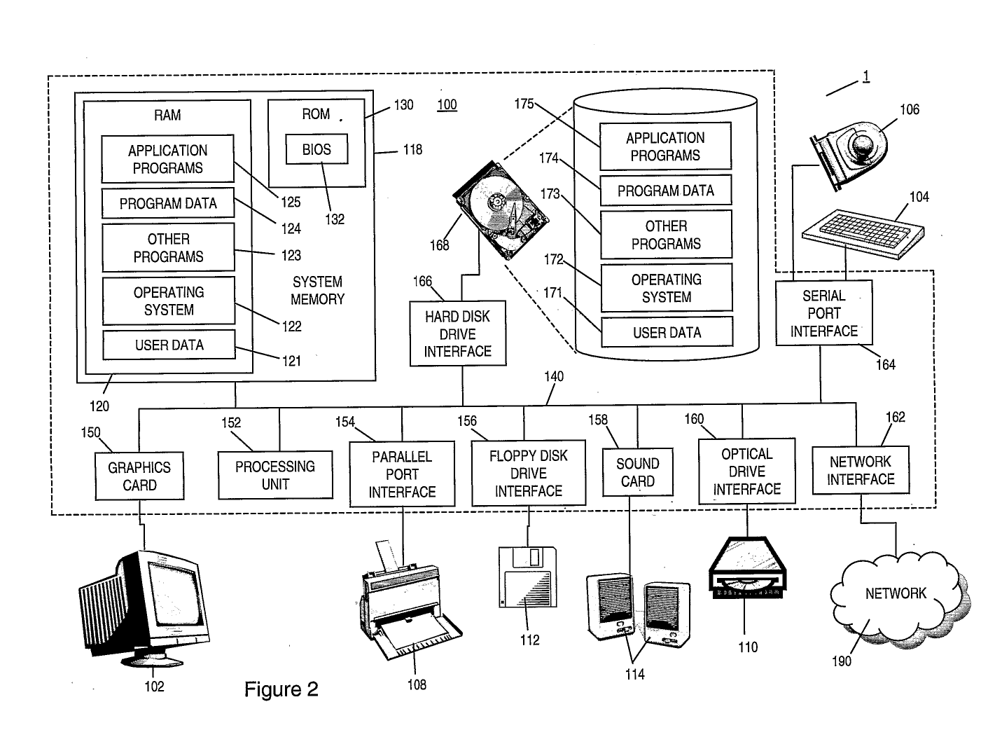

In view of the above, a general outline of a general purpose computer system which may act as any of the computer systems to be described with respect to the specific embodiments will now be described, with reference to FIGS. 1 and 2.

FIG. 1 illustrates a general purpose computer system which provides the operating environment for computer systems used in embodiments of the present invention. Later, the operation of the invention will be described in the general context of computer executable instructions, such as program modules, being executed by these computer systems computer. Such program modules may include processes, programs, objects, components, data structures, data variables, or the like that perform tasks or implement particular abstract data types. Moreover, it should be understood by the intended reader that the invention may be embodied within other computer systems other than those shown in FIG. 1, and in particular hand held devices, notebook computers, main frame computers, mini computers, multi processor systems, distributed systems, etc. Within a distributed computing environment, multiple computer systems may be connected to a communications network and individual program modules of the invention may be distributed amongst the computer systems.

With specific reference to FIG. 1, a general purpose computer system 1 which is generally known in the art comprises a desk-top chassis base unit 100 within which is contained the computer power unit, mother board, hard disk drive or drives, system memory, graphics and sound cards, as well as various input and output interfaces. Furthermore, the chassis also provides a housing for an optical disk drive 110 which is capable of reading from and/or writing to a removable optical disk such as a CD, CDR, CDRW, DVD, or the like. Furthermore, the chassis unit 100 also houses a magnetic floppy disk drive 112 capable of accepting and reading from and/or writing to magnetic floppy disks. The base chassis unit 100 also has provided on the back thereof numerous input and output ports for peripherals such as a monitor 102 used to provide a visual display to the user, a printer 108 which may be used to provide paper copies of computer output, and speakers 114 for producing an audio output. A user may input data and commands to the computer system via a keyboard 104, or a pointing device such as the mouse 106.

It will be appreciated that FIG. 1 illustrates an exemplary computer system only, and that other configurations of computer systems are possible which can be used with the present invention. In particular, the base chassis unit 100 may be in a tower configuration, or alternatively the computer system 1 may be portable in that it is embodied in a lap-top or note-book configuration. Other configurations such as personal digital assistants or even mobile phones may also be possible.

FIG. 2 illustrates a system block diagram of the system components of the computer system 1. Those system components located within the dotted lines are those which would normally be found within the chassis unit 100.

With reference to FIG. 2, the internal components of the computer system 1 include a mother board upon which is mounted system memory 118 which itself comprises random access memory 120, and read only memory 130. In addition, a system bus 140 is provided which couples various system components including the system memory 118 with a processing unit 152. Also coupled to the system bus 140 are a graphics card 150 for providing a video output to the monitor 102; a parallel port interface 154 which provides an input and output interface to the system and in this embodiment provides a control output to the printer 108; and a floppy disk drive interface 156 which controls the floppy disk drive 112 so as to read data from any floppy disk inserted therein, or to write data thereto. In addition, also coupled to the system bus 140 are a sound card 158 which provides an audio output signal to the speakers 114; an optical drive interface 160 which controls the optical disk drive 110 so as to read data from and write data to a removable optical disk inserted therein; and a serial port interface 164, which, similar to the parallel port interface 154, provides an input and output interface to and from the system. In this case, the serial port interface provides an input port for the keyboard 104, and the pointing device 106, which may be a track ball, mouse, or the like.

Additionally coupled to the system bus 140 is a network interface 162 in the form of a network card or the like arranged to allow the computer system 1 to communicate with other computer systems over a network 190. The network 190 may be a local area network, wide area network, local wireless network, or the like. In particular, IEEE 802.11 wireless LAN networks may be of particular use to allow for mobility of the computer system. The network interface 162 allows the computer system 1 to form logical connections over the network 190 with other computer systems such as servers, routers, or peer-level computers, for the exchange of programs or data.

In addition, there is also provided a hard disk drive interface 166 which is coupled to the system bus 140, and which controls the reading from and writing to of data or programs from or to a hard disk drive 168. All of the hard disk drive 168, optical disks used with the optical drive 110, or floppy disks used with the floppy disk 112 provide non-volatile storage of computer readable instructions, data structures, program modules, and other data for the computer system 1. Although these three specific types of computer readable storage media have been described here, it will be understood by the intended reader that other types of computer readable media which can store data may be used, and in particular magnetic cassettes, flash memory cards, tape storage drives, digital versatile disks, or the like.

Each of the computer readable storage media such as the hard disk drive 168, or any floppy disks or optical disks, may store a variety of programs, program modules, or data. In particular, the hard disk drive 168 in the embodiment particularly stores a number of application programs 175, application program data 174, other programs required by the computer system 1 or the user 173, a computer system operating system 172 such as Microsoft® Windows®, Linux™, Unix™, or the like, as well as user data in the form of files, data structures, or other data 171. The hard disk drive 168 provides non volatile storage of the aforementioned programs and data such that the programs and data can be permanently stored without power.

In order for the computer system 1 to make use of the application programs or data stored on the hard disk drive 168, or other computer readable storage media, the system memory 118 provides the random access memory 120, which provides memory storage for the application programs, program data, other programs, operating systems, and user data, when required by the computer system 1. When these programs and data are loaded in the random access memory 120, a specific portion of the memory 125 will hold the application programs, another portion 124 may hold the program data, a third portion 123 the other programs, a fourth portion 122 the operating system, and a fifth portion 121 may hold the user data. It will be understood by the intended reader that the various programs and data may be moved in and out of the random access memory 120 by the computer system as required. More particularly, where a program or data is not being used by the computer system, then it is likely that it will not be stored in the random access memory 120, but instead will be returned to non-volatile storage on the hard disk 168.

The system memory 118 also provides read only memory 130, which provides memory storage for the basic input and output system (BIOS) containing the basic information and commands to transfer information between the system elements within the computer system 1. The BIOS is essential at system start-up, in order to provide basic information as to how the various system elements communicate with each other and allow for the system to boot-up.

Whilst FIG. 2 illustrates one computer system which may be used in embodiments of the invention, it will be understood by the skilled man that other peripheral devices may be attached to the computer system, such as, for example, microphones, joysticks, game pads, scanners, or the like. In addition, with respect to the network interface 162, we have previously described how this is preferably a wireless LAN network card, although equally it should also be understood that the computer system 1 may be provided with a modem attached to either of the serial port interface 164 or the parallel port interface 154, and which is arranged to form logical connections from the computer system 1 to other computers via the public switched telephone network (PSTN).

Where the computer system 1 is used in a network environment, it should further be understood that the application programs, other programs, and other data which may be stored locally in the computer system may also be stored, either alternatively or additionally, on remote computers, and accessed by the computer system 1 by logical connections formed over the network 190.

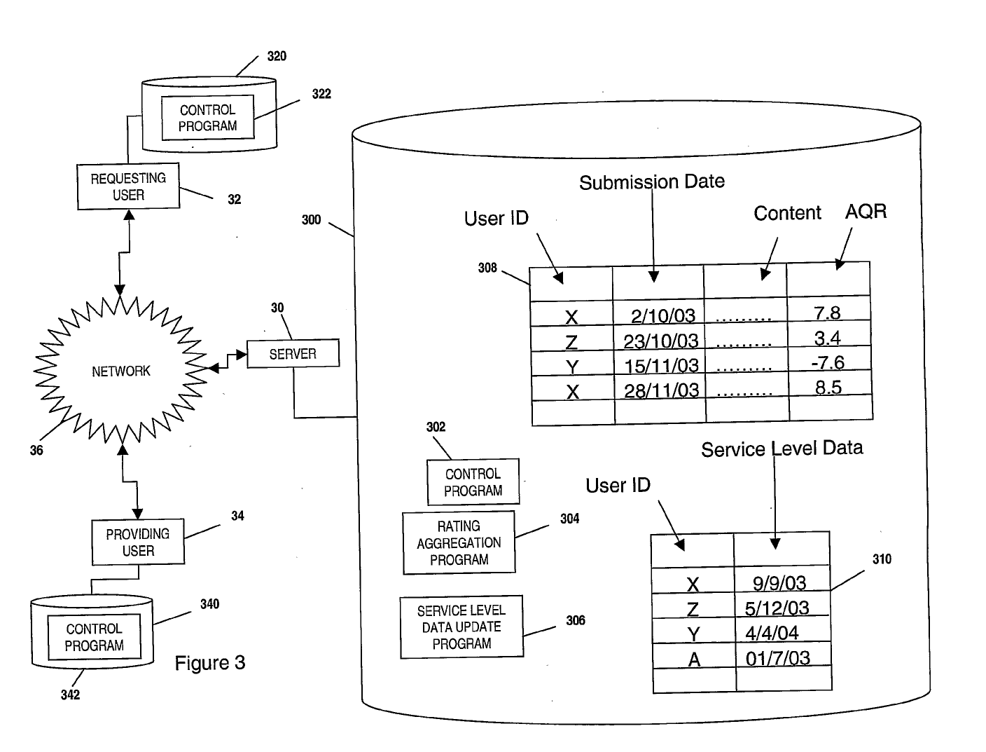

A first embodiment of the present invention which is based upon a classical centralised client-server architecture will now be described with respect to FIGS. 3 to 6. More particularly, with reference to FIG. 3, here a server computer 30 is provided which is arranged to communicate via a network 36 with a requesting user client computer 32, and a providing user client computer 34. Each of the server computer 30, requesting user client computer 32, and providing user client computer 34, may be general purpose computer systems as described above, provided with appropriate software. In particular, the requesting user client computer 32 is provided with a computer readable storage medium 320, such as a hard disk drive, optical disk drive, dvd drive, solid state storage, or the like, upon which is stored a control program 322, which is arranged to control the requesting user client computer 32 to perform in accordance with the embodiment of the invention. Similarly, the providing user client computer 34 is provided with a computer readable storage medium 340, such as a hard disk drive, optical disk drive, dvd drive, solid state storage, or the like, upon which is stored a control program 342, which controls the providing user client computer 34 to operate in accordance with the embodiment of the invention, in the manner to be described.

Additionally, the server computer 30 is provided with a computer readable storage medium 300, such as a hard disk drive, optical disk drive, dvd drive, solid state storage, or the like, upon which is stored a control program 302, a rating aggregation program 304, and a service level data update program 306. The control program 302 generally controls the server computer 30 to operate in accordance with the embodiment of the invention, such as by permitting the server to communicate appropriately with the requesting user client computer 32, and the providing user client computer 34. The rating aggregation program 304 and the service level data update program 306 are specific sub-component programs required by the server computer 30 to operate on the data stored therein during the operation of the embodiment of the invention, which operations will be described later.

Additionally stored on the computer readable storage medium 300 of the server computer 30 is a content item store data 308. The content data comprises sets of content items, such as text, audio data, visual data, or the like, which the server is able to provide to client computers in response to requests received therefrom. Each content item is stored together with the identification of the client computer who provided the content item, the date at which the content item was submitted to the server computer 30 for storage and subsequent provision to other users (the “submission date”), and an aggregate quality rating (AQR) which indicates the rating given to the content item by other users who have had it provided thereto.

In addition to the content item store data 308, the computer readable storage medium 300 of the server computer 30 also stores a set 310 of service level data, for each client computer registered with the server. Therefore, each set of service level data is indexed by the client computer ID (“user ID” in the diagram) to which it relates.

The service level data is very important to the operation of the embodiments of the present invention. This is because it defines the level of service which a user will receive in response to request for data such as content items. The level of service may be altered in many ways. For example, in some embodiments the level of service may depend upon how much of the content stored in the content item store 308 will be returned to a requesting user client computer 32 in response to a request for content. In other embodiments the level of service may relate to the transmission rate at which data such as content items are transmitted to a requesting user. Moreover, within embodiments of the invention to be described the values of the service level data are dependent upon ratings given by other users to data such as content items provided by the user to which any particular service level data value relates. Alternatively, the ratings may relate to the level of service provided by the user in servicing requests of other users, such as, for example, the transmission rate at which the user serves other users' requests. This latter approach may have particular applicability in peer to peer embodiments, described later.

Moreover, the service level data may take many forms. Within the diagram, and in, the preferred embodiment, the service level data may take the form of a date and/or time stamp, specifying a date and/or time which acts as a cut-off point for content to be served to a requesting user by the server. That is, the date and/or time stamp stored as the service level data for any particular registered user specifies the latest date of content which may be served to the requesting user in response to a request.

Alternatively, in other embodiments, the service level data may take the form of a geographical position, and a distance value for each user. More specifically, in such an embodiment the geographical location of each registered client user is stored with the service level data together with a distance threshold. Within the content item store 308, for each content item as well as storing the submission date of that content item, the geographical position of the providing user who provided the content is also stored. Then, the service level data in the form of the distance threshold can be used to specify which content items may be provided to a requesting user in response to a request therefore, based upon the distances between the providing users, and the requesting user.

Furthermore, in further embodiments the service level data may be a quality value, which may then be compared to individual quality values given to specific content items, for example based upon previous user reviews. This then allows the service level data to act as a so-called “quality horizon” defining the scope of content which may be accessible by a user based upon the quality rating given to each piece of content.

Moreover, in yet further embodiments the service level data may be a reputation value, which may then be compared to reputation values given to particular content based upon a reputation of the user who provided the content. For example, the reputation information may be derivable from previous user reviews of content provided by that same user. This then allows the service level data to act as a so-called “reputation horizon” defining the scope of content which may be accessible by a user based upon the reputation rating given to the user who supplied each piece of content.

In a further embodiment, the service level data may simply comprise a percentage value, fraction, or the like, specifying the percentage of the available content items stored in the contents item store 308 which may be returned to a requesting user in response to a request therefrom. Thus, for example, if the service level data for client X was 60%, then only 60% of the available content items would be returned to that client X upon request.

In other embodiments, the service level data may instead take the form of a transmission rate value, indicating a maximum (or minimum) transmission rate at which data should be transmitted to the user in response to service requests received therefrom. Such a value may take the form of an absolute value or a percentage value based upon maximum available transmission rate.

The service level data may of course take other forms, depending upon the particular service characteristic which it is desired to alter.

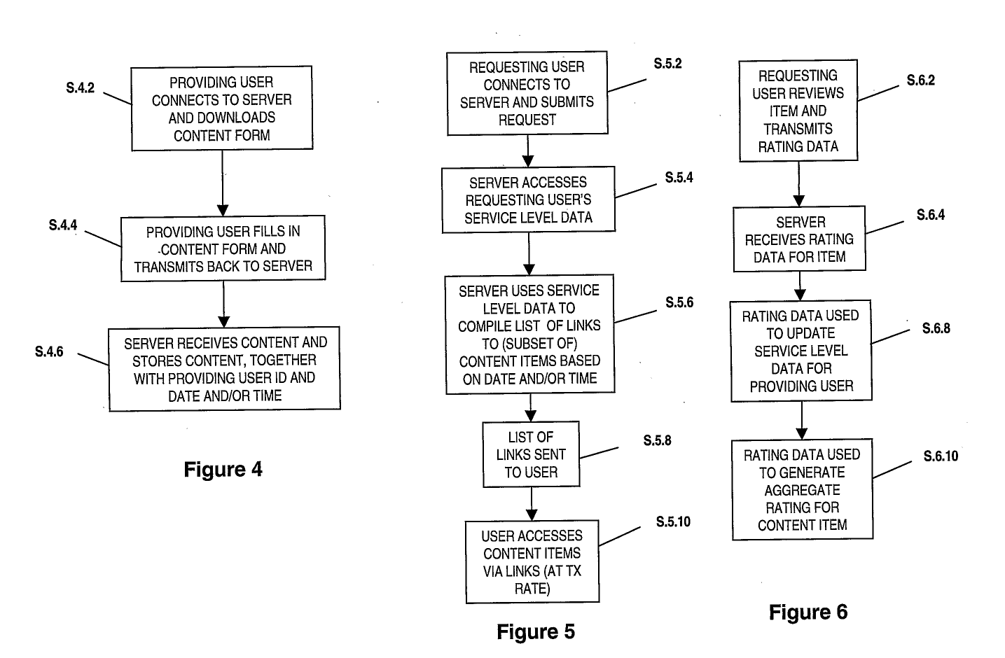

Having described the basic elements of the first embodiment of the invention, the operation of those elements in performance of the embodiment will now be described with respect to FIGS. 4, 5, and 6.

The basic premise behind the first embodiment of the invention is to provide a client server based centralised data provision system which stores data such as content items centrally, together with service level data for each registered client user. The service level data for each registered client user is changed when review rating data indicating a review value given by another user to a content item or the like provided by, the particular client user for which the service level data is stored is received. Additionally, when a user requests data such as content items from the server computer 30, then that user's service level data is used to determine the level of service which is applied by the server to service that request. The rationale behind this operation is that in order to obtain a greater level of service in response to a request, any particular client user will have to make quality data or content contributions him or herself, such that good review rating values are received and his service level data defining the level of service he receives may then be changed. It is thought that such operation should incentivise client users to provide good quality content to the server computer 30, which content may then be provided to other users.

In view of the above described overview, FIGS. 4, 5, and 6, illustrate respective different operations which may be performed by the first embodiment of the invention. In particular, FIG. 4 illustrates those steps which are performed when a client computer provides data such as a content item to the server computer 30 for storage, FIG. 5 illustrates those steps which are performed when a client computer requests content from the server computer 30, and FIG. 6 illustrates how the service level data for a client computer may be updated, in dependence on the ratings of content provided by that user, given by other users.

With reference to FIG. 4, therefore, the steps involved in a user providing data such as a content item to the server computer will now be described.

Firstly, at step 4.2 the providing user computer 34 connects to the server computer 30, and downloads a content provision form therefrom. This content provision form may be in the form of a web page, or the like, which allows the user to enter or store content therein, which may then be transmitted back to the server. Next, at step 4.4, the user of the providing user client computer 34 fills in the content form, and controls the providing user client computer 34 to transmit the form back to the server computer 30. At step 4.6, the server computer 30 receives the content, and stores the content in the content set 308, together with the providing user client user computer ID, and date and/or time of the content submission. Optionally, depending on the form of the service level data, the location of the providing user client computer may also be stored together with the content.

At this point, therefore, the providing user client computer 34 has communicated new content to the server computer 30, which has stored the new content in its content store 308.

Turning now to FIG. 5, this illustrates the steps involved in the first embodiment for the server computer to provide content to a requesting user client computer. Here, at step 5.2 a requesting user client computer 32 connects to the server computer 30 via the network 36, and submits its request for content. The request may take the form of a search request for specific subject matter, as is well known in the art.

Next, at step 5.4, the server accesses the requesting user client computer's service level data in the service level data store 310, to determine the level of service to which the requesting user client computer 32 is entitled. At the same time, the server computer 30 may search through the available content items stored in the content item store 308, to determine those content items which match the search request based on subject matter, keywords, review rating, or the like. Following this, at step 5.6 where the service level data is of the appropriate format the server computer 30 uses the service level data accessed at step 5.4 to compile a list of links to a subset of the content items which match the requesting user's search request. Thus, for example, where the service level data is a time and/or date stamp, at step 5.6 the server reviews the submission dates of those content items which were found to match the search request, and places links (such as URLs) to those content items whose submission date was prior to the time and/or date stamp stored in the requesting users service level data, in the subset. Where the service level data is not appropriate to perform such content sub-setting, such as, for example, where it relates to transmission rate value or the like, then such sub-setting is not performed, and at step 5.6 the server simply compiles a list of content items or links which meet the search request from all available content items.

Next, at step 5.8 the subset of links is sent to the user 32 via the network 36. At step 5.10, the requesting user client computer 32 receives the (sub-setted, if appropriate) list of links, and can access the listed content items from the server computer via the links. The links may be URLs, or the like, which instruct the server computer 30 to access the particular linked to content item within the content store 308, and provide it to the user. Where the service level data is in the form of a maximum transmission rate, then any content items served to the user in response to a request via the links are served at a bandwidth up to but not greater than the maximum rate indicated by the service level data.

Thus, in accordance with the operation of FIG. 5, the service level data is used either to determine a subset of matching content items to a search request, and that subset is then made available to the user, or to determine a maximum transmission rate at which content is supplied to the user. In order to gain access to additional content items not within the subset, or to achieve a higher transfer rate, a requesting user must provide a good quality content item to the server him or herself which can then receive good review ratings from other peers, such that his service level data may then be updated, thus permitting him increased access to other content items, or increased bandwidth. By restricting the requesting user to a subset of the available content items, or to a reduced transmission rate, it is thought that the provision of additional good quality content items from the requesting user will be encouraged.

Turning now to FIG. 6, this illustrates the mechanism by which service level data may be changed to allow a client user more access to content, or an improved transmission rate.

More particularly, the process of FIG. 6 is based upon the premise that a client user's service level data may be updated in dependence upon review ratings given by other client users to the data items such as content items which he has provided. Where good reviews are received, then the service level data may be updated to a greater extent than would otherwise be the case, but where bad reviews are received, then the service level data may be updated to a lesser extent, not at all, or perhaps even decremented.

Specifically, with reference to FIG. 6, at step 6.2 a user who has requested content items and been served with those items may review the item, and follow a link provided with the item to a ratings page provided by the server computer 30, which allows the requesting user to specify a rating for that item. This rating data is then transmitted back to the server computer 30, and received at step 6.4. Next, at step 6.8, the server computer 30 uses the received rating data to update the service level data for the providing user who provided the content item in the first place (the content item having been provided, for example, by the process of FIG. 4). As a non limiting example of the rating data, and how this may be used to update the service level data for the providing user, in a particular variant of the first embodiment the rating data may be a number from −10 to +10. Negative numbers are intended in this context to mean that the accessed quality of the content item is poor. Positive numbers are intended to mean that the content has been assessed to provided useful information (of varying value) and so to add to the overall utility of the content provision system.

When the rating data is in this form, the server computer 30 checks whether the requesting user who has provided the rating has reviewed that content item before (a list of requesting users may be kept for each content item, for this purpose) and the rating value is added to the service level data value to update the service level data. Thus, where the service level data is a date and/or time stamp, then that stamp may be brought forward by an amount indicated by the review (e.g. in number of days). Alternatively, where the service level data is a distance threshold, a percentage or fraction, or a maximum allowable transmission rate (expressed absolutely or as a percentage of maximum available rate) then similarly those thresholds, or percentages, or fractions, may be increased by the rating value. To prevent a requesting user providing multiple reviews of a content item, and therefore artificially increasing the service level data of the providing user, following the incrementing of the service level data by the review, if the requesting user had previously provided a rating, then the service level data is then decremented by that previous rating. Thus, for example, where the service level data is a date stamp, if the previous rating had been seven, and the new rating is nine, the time stamp is brought forward nine days to account for the new rating, but then decremented by seven days to discount the previous rating. Such a mechanism prevents a requesting user from artificially increasing a providing user's service level data value.

Once the rating data has been used to update the service level data, then the next step, at step 6.10, is to use the same rating data to update or generate an aggregate quality rating for that content item. It will be recalled from the above discussion of FIG. 3 that the content item store 308 stores for each content item an aggregate quality rating, which is preferably, although not exclusively, the output of an exponential smoothing function to various ratings values which are received from other users over time. An example exponential smoothing function which may be used for this purpose may be found at http://www.fourmilab.ch/hackdiet/www/subsubsection1_{—}4_{—}1_{—}0_{—}8_{—}3.html. Once the AQR value for the content item has been updated, the process of FIG. 6 is finished.

The first embodiment of the invention therefore provides a client-server architecture based system which regulates service provided to users based upon the peer reviews of content items or other data provided from client users themselves. The regulation of the service is performed by storing for each client user service level data, which is updated or changed in dependence on the reviews received from other users. The service level may be changed by changing the amount of data which a user has access to, or by changing the transmission rate at which data is supplied to the user.

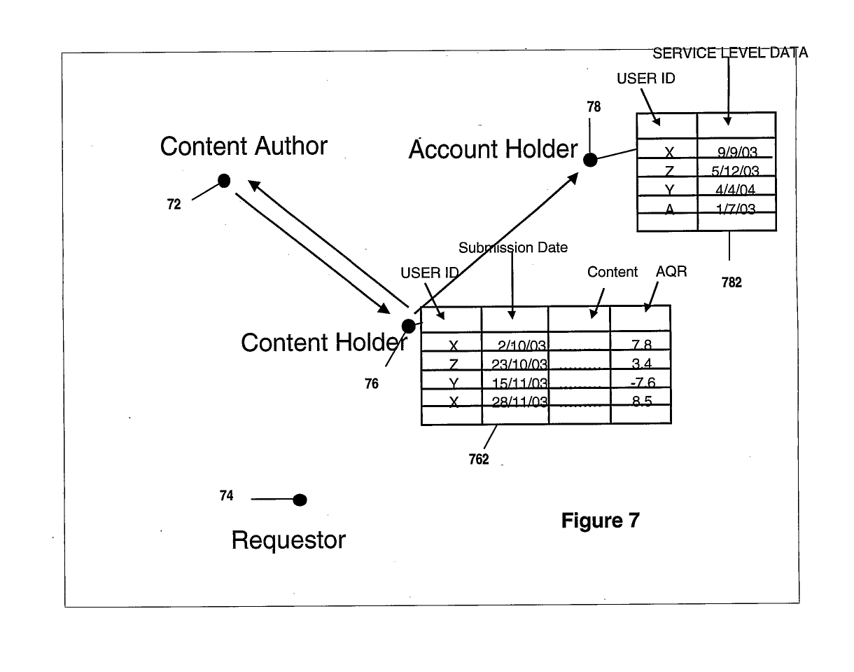

A second embodiment of the present invention will now be described with respect to FIGS. 7 to 15. The second embodiment and the various variants thereof to be described are based upon a peer-to-peer architecture, with no central server as such. In this respect, each peer computer system, which may be a general purpose computer system such as that previously described, is provided with software which preferably allows it to perform each of the actions required in taking certain roles within the second embodiment of the invention. During each interaction each peer computer then adopts one or more of the available roles.

More specifically, within the second embodiment during each interaction a peer computer system adopts one or more of the following roles:
1. Content authors 72, being peers who have content items or other data that they intend to submit for provision to other users;
2. Account holders, being peers who, acting independently, are responsible for storing the service level data for other peers;
3. Content holders, being those peers who store the content items submitted by content authors; and
4. Requesters 74, being those peers who in an individual interaction, wish to access content items.

By “content items” in the above, it should be understood that this can be extended more generally to other data items.

Note that preferably each peer adopts each role in different transactions. That is, each peer may act as the content holder for content provided by other peers, and similarly each peer may be an account holder for some others of its peers (preferably more than one to improve resilience and security). Moreover, each peer acting as a content author provides content items or other data to be held by content holders (again preferably more than one to improve resilience and security).

Individual peer computer systems are uniquely identified by peer identifiers, and the content items provided thereby are also uniquely identified by content identifiers. Peer identifiers are preferably based on cryptographic certificates, and so are un-forgeable and can be used to sign messages and content. In order to allow the second embodiment of the invention to operate, the peer to peer system as a whole operates two distributed algorithms, the operation of which is already known in the art and described in, for example; Castro et al “Secure Routing For Structured Peer to Peer Overlay Networks”ACMSIGOPS operating systems review, Vol 36, issue Si Winter 2002 special issue: Peer-to-Peer infrastructure, pp 299-314, 2002. These two algorithms are:
1. A distributed search mechanism (DSM) that, provided with attributes of a search, is able to identify a set of content items that may meet those search attributes; and
2. A distributed hash table (DHT) that can be used to
   a) take a peer identifier and return an IP address at which that peer can be contacted;
   b) take a peer identifier and return a set of IP addresses being the peers responsible for storing the account for the identified peer; and
   c) take a content identifier and return a set of IP addresses being the peers responsible for storing the content item itself.

We assume that the distributed hash table cannot be subverted by content authors so that they can intercept all messages to their own account holders and maliciously rewrite them. This can be achieved by using secure versions of the distributed hash table, such is that known in the art as Secure Pastry, and described in ibid.

In view of the above, and referring to FIG. 7, the content holders are each provided with a content item store 762, which is similar to the content item store 308 described in respect of the first embodiment, and which has identical attributes thereto. Additionally, the account holder peers 78 are provided with respective service level data store 782s, which again are similar to the service level data store 310 of the first embodiment, and which may have similar attributes thereto. In particular, the service level data stores 782 may store service level data in any of the formats described previously in respect of the first embodiment i.e. a time and/or date stamp, a percentage or fraction, a geographical position and a distance threshold, or a transmission rate value.

Given the above described peer to peer infrastructure, in common with the first embodiment the second embodiment provides a data provision method and system which regulates the level of service which is provided to a requesting peer based upon service level data which is stored for that peer, the service level data being used to generate a subset of available content items in response to a request therefor, or to specify a transmission rate at which data such as content items are transmitted to a user. The differences between the second embodiment and the first embodiment is that the second embodiment is based upon peer-to-peer technology and hence the message flows between peers are more complicated than in the case of the client-server architecture. The processes performed by the peers within the second embodiment of the present invention will now be described

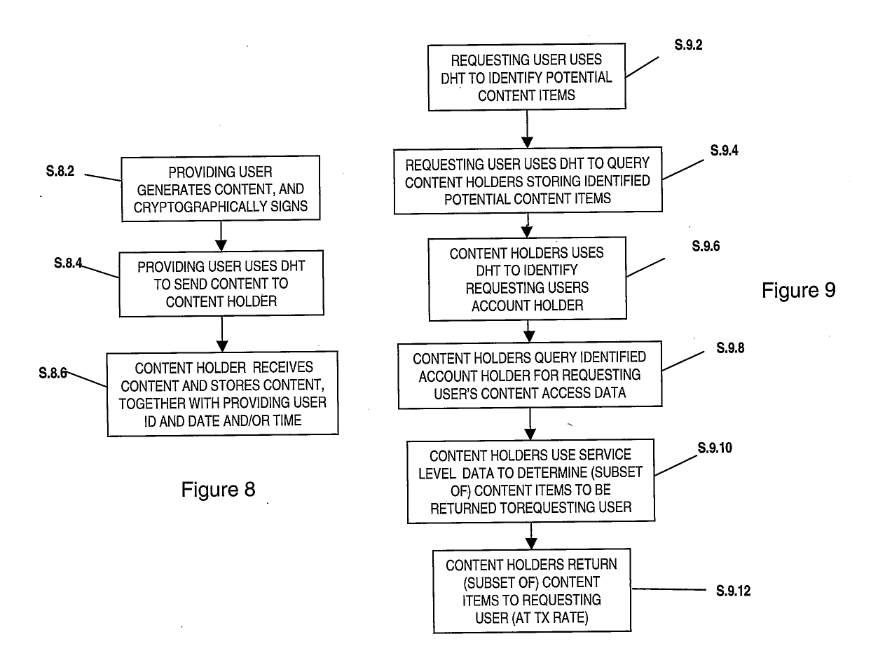

More particularly, with reference to FIGS. 7 and 8 those processes performed by the peers within the system when a peer submits new data such as content items or the like for storage by the system will now be described.

Firstly, at step 8.2 a providing peer in the form of a content author 72 generates a new content item, and cryptographically signs that content with his digital signature. Next, at step 8.4 the content author 72 uses the distributed hash table to identify the relevant content holder 76 for that content, and sends the cryptographically signed new content to the content holder.

At step 8.6 the content holder receives the cryptographically signed content, and stores the content in its content store 762 together with the peer ID of the content author and a date and/or time stamp of when the content item was received. Optionally, depending on the variant of the second embodiment which is being used, the content holder 76 may also store location data relating to the location of the content author 72, if the service level data is geographically based.

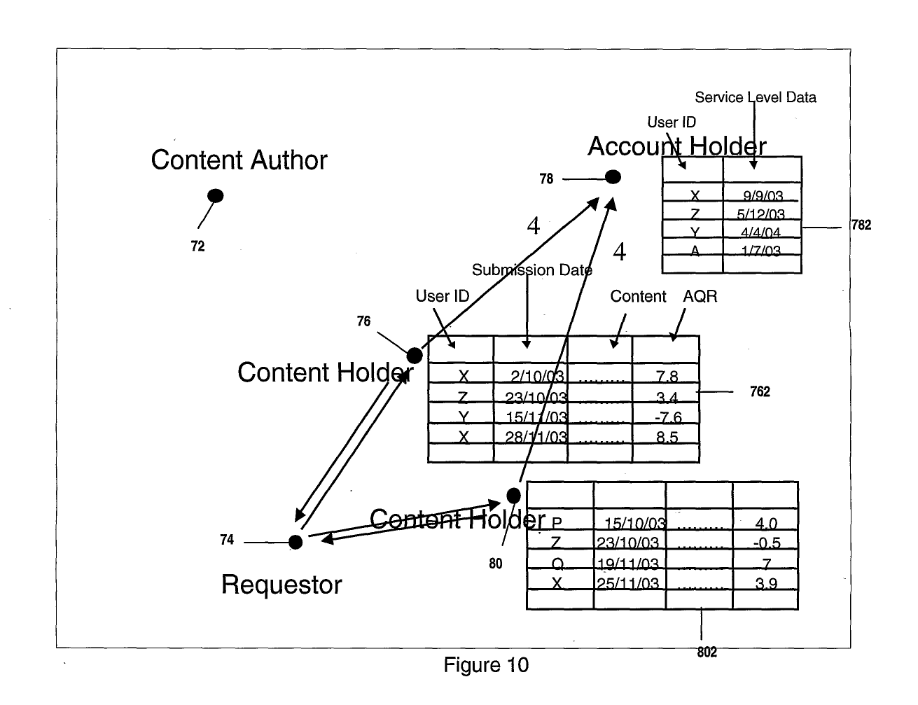

The operation of the second embodiment in servicing requests for content from requesting peers 74 will now be described with respect to FIGS. 9 and 10.

Firstly, at step 9.2 a requesting peer 74 uses the distributed search mechanism to identify potential content items which meet his search attributes. Then, at step 9.4 the requesting user uses the distributed hash table to identify those content holders 76 and 80 which are storing the identified content items which potentially meet the requesting user's search criteria, and access queries are then sent to the identified content holders 76 and 80, asking those content holders to provide access to the stored content items, either by providing copies of the content items themselves, or links thereto.

Following the receipt of the access queries, at step 9.6 the content holders 76 and 80 use the distributed hash table to identify the account holder 78 for the requesting user 74, such that the content holders may then query the identified account holder for the requesting user 74's service level data, at step 9.8. The account holder 78 then responds to the review holders' query with the service level data for the requesting user 74, and at step 9.10 the content holder 76 and 80 use the service level data to determine the level of service to be applied to the request. For example, where the service level data is in an appropriate format (such as a time stamp or the like) a subset of the identified content items to be returned to the requesting user. The precise mechanism used in this subset determination step will depend upon the format of the service level data, but generally the same steps as were performed by the server computer 30 at step 5.6 of the first embodiment may be performed by each content holder 76 and 80 on its own stored content items to produce respective subsets thereof. Alternatively, where the service level data is a transmission rate value, then no sub-setting of relevant content items is performed.

Next, at step 9.12 the content holders return their respective subsets of content items (or links thereto) to the requesting user 74, or return all of the identified content at the determined transmission rate, depending on the format of the service level data.

Thus, within the second embodiment, as in the first embodiment, the service level data of the requesting user is used to either limit the content items which are returned to the requesting user in response to a request received therefrom, or to limit the transmission rate at which content is served to the requesting user.

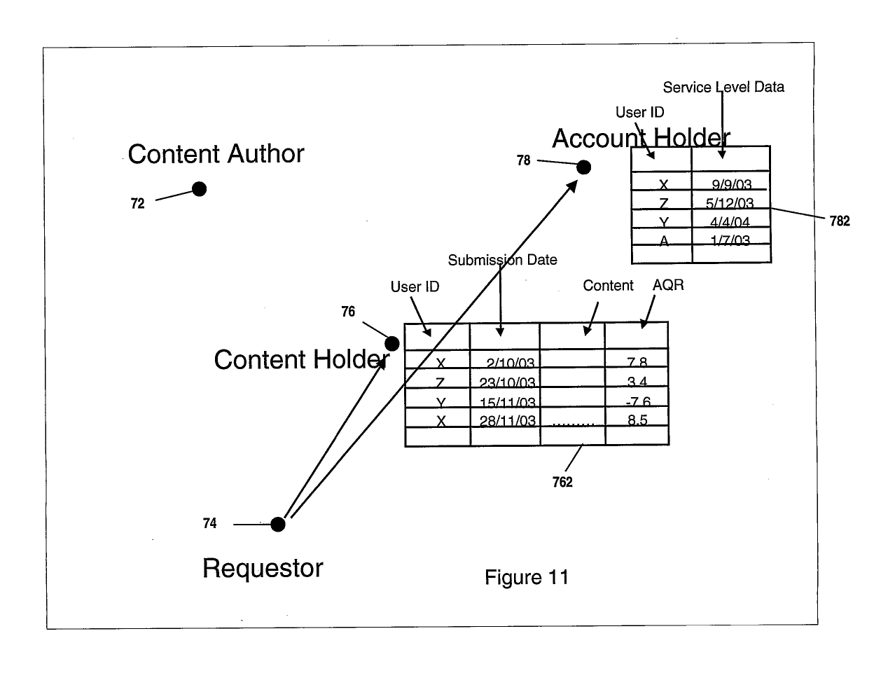

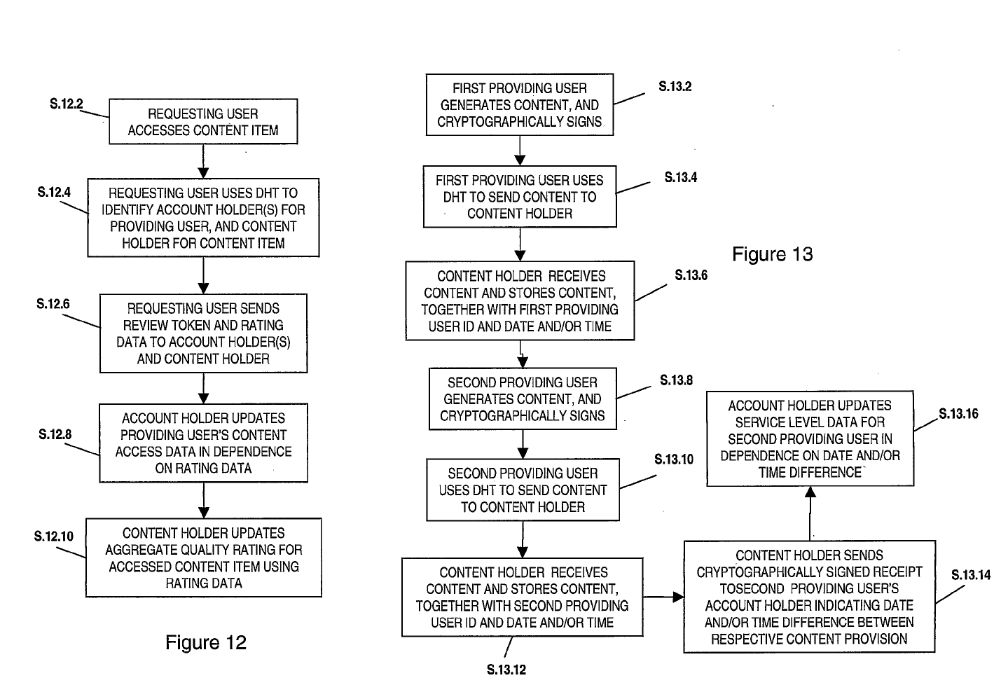

Thus far, with respect to the second embodiment we have described how new content items may be submitted, and how requests for content or data may be serviced by peers. The mechanism by which users' service level data may be changed will now be described with respect to FIGS. 11 and 12, based upon a ratings mechanism, of ratings of content items by requesting peers.

FIG. 12 illustrates the process performed by this mechanism. In particular, following a request for content items such as that shown in FIG. 9, a requesting user 74 accesses a particular content item. Here, in addition to being provided with the content item (or a link thereto), by the content holder 76, the requesting user is also provided with a rating token, being a unique token signed by the content holder, and including the content identifier, and the content author identifier with a unique nonce.

In order to review the accessed content item, at step 12.4 the requesting user 74 uses the distributed hash table to identify the account holder or holders for the content author of the accessed content item, and also the content holder of the content item. Then, at step 12.6 the requesting user 74 sends the review token which is received from the content holder with the content item together with the rating data to both the identified account holder (or holders), and content holder.

Next, at step 12.8 the account holder updates the content author's service level data in dependence on the received rating data. As mentioned previously, there are many mechanisms by which this may be achieved, depending upon the format of the rating data, but the same mechanism as described in respect of step 6.8 of the first embodiment may equally be used here to update the service level data. Following this update, or at the same time, at step 12.10 the content holder updates the aggregate quality rating (AQR) for the accessed content item using the rating data. The precise mechanism by which this may be achieved may be that as described in respect of step 6.10 of the first embodiment.

According to the second embodiment, therefore, a peer-to-peer architecture based data provision system is provided which uses service level data which may be changed in dependence upon ratings of the provided content by other peers.

A number of further modifications to the second embodiment of the invention will now be described in respect of FIGS. 13, 14, and 15, which may be used in combination with that as described above.

A first modification will be described with respect to FIG. 13. This illustrates a mechanism by which the service level data for one of the peers may be updated in response to the time elapsed between that peer providing content with respect to the provision of earlier content by another peer. Such a mechanism may be particularly useful in newsgroup or bulletin board applications, wherein a first user posts a question or request to the newsgroup or bulletin board, and a second user then provides an answer to the question, or serves the request in a timely fashion. In particular, the speed of response in serving the request or answering the question can result in the serving peer's service level data being updated to a greater extent than would otherwise be the case.

In view of the above, at step 13.2 a first providing user may generate content, which he then cryptographically signs. At step 13.4 the first providing user uses the distributed hash table to send the content to an appropriate content holder, and at step 13.6 the appropriate content holder receives the content and stores the content, together with the peer ID of this first providing user, and the data and/or time of submission of that content. In the event of a news group application, for example, this content generated by the first providing user may be a question or a request, or the like.

Assume now that a second providing user wishes to answer the question or serve the request. To answer the question or serve the request, the second providing user generates content to answer the question or to serve the request, and cryptographically signs the content. Next, at step 13.10 the second providing user uses the distributed hash table to identify the content holder to which the content must be sent, and sends the content to that content holder. At step 13.12 the identified content holder receives the content and stores it, together with the peer ID of the second providing user, and the date and/or time at which the content was received. Therefore, in the context of the newsgroup application, the second providing user has answered the first providing user's question, or served his request, by providing the content to the content holder. The second providing user should therefore be rewarded for this timely service of the first providing user's request or question.

To achieve this reward, at step 13.14 the content holder sends a cryptographically signed receipt to the second providing user's account holder, the receipt indicating the date and/or time difference between the respective content provision by the first providing user, and the second providing user. That is, this is the time difference between the date and/or time of receipt of the content item from the first providing user, and the date and/or time of receipt of the content item from the second providing user.

Having received this receipt, at step 13.16 the account holder updates the service level data for the second providing user in dependence upon the date and/or time difference. How this update is achieved will depend upon the format of the service level data, but, for example, where the service level data is a time and/or date stamp itself, the stamp may be incremented by an amount equal to a fixed amount (10 days, say) minus the indicated time and/or date difference. Thus, the smaller the indicated difference, the greater the service level data is updated.

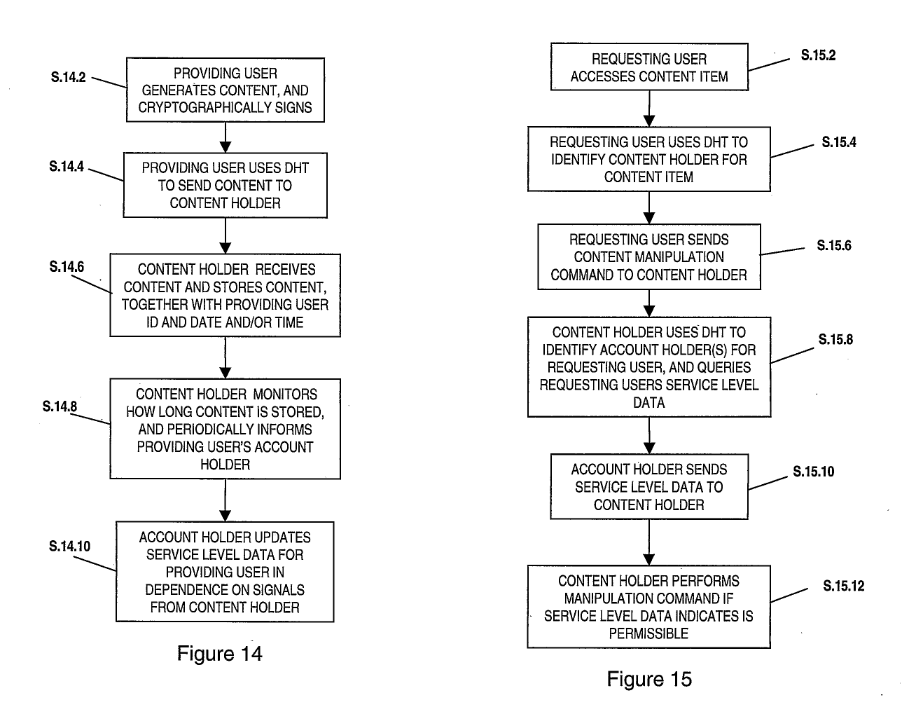

A further modification of the second embodiment will now be described with respect to FIG. 14.

In FIG. 14, the service level data of content authors is updated in dependence on the amount of time that a particular content item has been stored by a content holder. Thus, at step 14.2 a content author generates content and cryptographically signs the content. Then, at step 14.4 the content author uses the distributed hash table to identify an appropriate content holder for the content, and sends the content to that content holder. At step 14.6 the content holder receives the content and stores the content, together with the peer ID of the content author, and the date and/or time at which the content item was received. Then, at step 14.8 the content holder monitors how long the content is stored, and periodically informs the content author's account holder that the content item is still being stored. In response to such a message from the content holder, at step 14.10 the account holder for the content author updates the service level data for the content author. The precise mechanism by which the service level data may be updated may be any of those mechanisms previously described, depending upon the service level data format.

A further modification of the second embodiment is described next with respect to FIG. 15. In this modification, the service level data is used not only to specify which content is returned in response to a request for content, but also specifies whether a particular requesting user is able to perform a content manipulation on content stored in a content holder. Particular content manipulations envisaged are those such as edit, delete, or the like.

In view of the above, and with reference to FIG. 15, within this variant of the second embodiment at step 15.2 a requesting user 74 accesses a content item using, for example, the process of FIG. 9. If the requesting user then wishes to manipulate that content item, such as to edit it, or delete it, then at step 15.4 the requesting user uses the distributed hash table to identify the content holder for the content item, and at step 15.6 sends a content manipulation command to the content holder specifying the manipulation to be performed.

However, since not every peer may be entitled on the basis of its service level data to validly manipulate content, in order to verify whether the requesting user is so entitled, the content holder uses the distributed hash table to identify the account holder or holders for the requesting user, and queries the requesting user's service level data, at step 15.8. In response to this query, at step 15.10 the account holder sends the service level data to the content holder, and at step 15.12 the content holder performs the manipulation command if the service level data indicates this is permissible. This indication will usually be whether or not the service level data meets a particular threshold value which indicates that a requesting user is able to manipulate the content.

Such a mechanism further rewards peers to provide content such that their service level data is updated to a level which is sufficient to allow them to manipulate content. This is further thought to encourage users to submit content for provision.

Further modifications may also be made to the account holder mechanism used in the peer to peer embodiment described above. In particular, here the account holders mechanism can use other distribution schemes if, for a particular application, they are secure or more efficient. For example, the ratings of a contributed review may be stored, not in the Account Holders, but only in the content Holders. In this scheme, the Requestor sends his rating only to the content Holders who update an aggregate review rating (as long as the rating sent is valid and not duplicated). They then pass on this updated aggregate review rating to the Account Holder who uses this figure (rather than the raw rating) to update the content Author's service level data For example, its service level data may then be based upon the maximum aggregate review rating received.

Additionally or alternatively, when the formulae used to update service level data are such that service level always increases (as will generally be the case) then the content Authors can hold their own service level as signed tokens generated by their Account Holders. Then they can present this signed token with their requests which allows content Holders to check the content access without querying an Account Holder.

Further modifications may also be made to the mechanism by which the aggregate quality ratings (AQRs) of each content item are calculated. More particularly, the particular AQR mechanism we outlined above is preferable because of its simplicity, and the fact that it can be used to weight (bias) the more recently-received ratings. It also requires minimal ‘memory’, because all prior review ratings can be discarded once the AQR is updated. But it has the disadvantage that ‘1 peer, 1 vote’ policies can't be enforced.

To overcome any such problems, a slightly different scheme may be adopted in the peer to peer architecture in which:

i) Review ratings are only sent to the Account Holder (and not the content Holder).

ii) Account Holder's are then able to respond to two sorts of queries on an account, as follows:—
a) The service level data of the peer (as before); and
b) The AQR for a particular report

Content Holders may then (occasionally) query the Account Holders associated with content they hold, and the AQRs are then calculated by each of the Account Holders and then returned to, the requesting content Holder. This version of the scheme allows ‘multiple votes’ to be handled in the same ways as when determining the service level data, as described previously.

Further modifications may be made to the above described embodiments of the invention in accordance with the following.

All the embodiments described previously can be supplemented with the following further options. The first option, applicable for example to step 6.8 in FIG. 6, is to weight the rating data according to the current content access data value of the requesting user (or better), weight it according to the average rating received for the requesting user's recent content). This exploits the fact that users receiving high ratings for their own content are more likely to accurately assess the quality of others' content.

The second optional mechanism provides a simple incentive mechanism to actually perform the rating. In the first instance this requires that the cost of rating a piece of content is minimised. As well as the choice of rating scale and interface design, this may include ensuring that the rater's identity remains anonymous (at least to the author of the content—who's content access data the rating ultimately affects). In addition, a small positive incentive to rate content may be desirable. An insecure, but lightweight means to do this would simply be increment a user's content access data for each rating that they make. A more secure alternative—that would ensure that users took care in performing the rating—would be to statistically check that a particular user's ratings were generally in line with the other feedback received on that piece of content (and to penalise the content access data if not).

1. A data provisioning method, comprising the steps:
storing data items or data defining access to data items for provision to users;
maintaining, for one or more users, respective service level data usable to determine a level of service to be provided to the respective users;
receiving data items or data defining access to data items from users for provision to users;
receiving rating data from one or more users relating to data items provided to those users;
changing the respective service level data for those users from which data items or data defining access to data items were received in dependence upon received rating data relating to those received data items or data defining access to data items; and
providing service to a user in dependence on the service level data for that user.

2. A method according to claim 1, wherein the service level data comprises a proportion value, and wherein the servicing step comprises determining a sub-set of the data items or data defining access to data items corresponding to a proportion of the available data items or data defining access to data items substantial corresponding to the proportion value; and providing the sub-set to the requesting user.

3. A method according to claim 1, wherein each data item or set of data defining access to a data item has a property having a value, and the service level data comprises a content access value relating to the property, wherein the servicing step comprises determining a sub-set of the data items or data defining access to data items in dependence on the respective values, and providing the sub-set to the requesting user.

4. A method according to claim 3, wherein the property values and content access values are times and/or dates.

5. A method according to claim 3, wherein the property values and content access values are geographical positions.

6. A method according to claim 1, wherein the service level data is a transmission rate value, and the servicing step comprises determining a set of data items or data defining access to data items which meet the request, and providing the set to the user at a transmission rate in dependence on the transmission rate value.

7. A method according to claim 1, wherein the changing step further comprises receiving requests for specific data items or data defining access to data items from users, and changing the service level data for the user from which the requested data item or data defining access to data was received.

8. A method according to claim 1, wherein the changing step further comprises monitoring the time or date at which a first data item or data defining access to a data item is received in relation to the time or date a second data item or data defining access to a data item is received, and changing the service level data of the user from the which first data item or data defining access to a data item was received in dependence on the difference between the times and/or dates.

9. A method according to claim 1, wherein the changing step further comprises monitoring the time since the receipt of a data item or data defining access to a data item, and changing the service level data of the user from which the data item or data defining access to the data item was received in dependence on the monitored time.

10. A method according to claim 1, and further comprising the step of permitting a user to perform manipulations of the stored content items or data defining access to content items in dependence on the user's service level data.

11. A method according to claim 1, collectively performed by at least a sub-set of peers within a peer to peer network.

12. A method according to claim 1, wherein the rating is weighted according to the service level value of the rating user.

13. A computer program or suite of computer programs arranged such that when executed by a computer system or a plurality of computer systems it/they cause the computer system or systems to perform the method of claim 1.

14. A computer readable storage medium storing a computer program or any one or more of a suite of computer programs according to claim 13.

15. A data provisioning system, comprising:
a data store storing:
i) data items or data defining access to data items for provision to users; and
ii) for one or more users, respective service level data usable to determine a level of service to be provided to the respective users;
data receiving means arranged in use to receive:
i) data items or data defining access to data items from users for provision upon request to users; and
ii) rating data from one or more users relating to data items provided to those users; and
a processor arranged in use to perform the following steps:
i) change the respective service level data for those users from which data items or data defining access to data items were received in dependence upon received rating data relating to those received data items or data defining access to data items; and
ii) provide service to a user in dependence on the service level data for that user.

16. A system according to claim 15, wherein the service level data comprises a proportion value, and wherein the servicing step comprises determining a sub-set of the data items or data defining access to data items corresponding to a proportion of the available data items or data defining access to data items substantially corresponding to the proportion value; and providing the sub-set to the requesting user.

17. A system according to claim 15, wherein each data item or set of data defining access to a data item has a property having a value, and the service level data comprises a content access value relating to the property, wherein the servicing step comprises determining a sub-set of the data items or data defining access to data items in dependence on the respective values, and providing the sub-set to the requesting user.

18. A system according to claim 17, wherein the property values and content access values are times and/or dates.

19. A system according to claim 17, wherein the property values and content access values are geographical positions.

20. A system according to claim 15, wherein the service level data is a transmission rate value, and the servicing step comprises determining a set of data items or data defining access to data items which meet the request, and providing the set to the user at a transmission rate in dependence on the transmission rate value.

21. A system according to claim 15, wherein the changing step further comprises receiving requests for specific data items or data defining access to data items from users, and changing the service level data for the user from which the requested data item or data defining access to data was received.

22. A system according to claim 15, wherein the changing step further comprises monitoring the time or date at which a first data item or data defining access to a data item is received in relation to the time or date a second data item or data defining access to a data item is received, and changing the service level data of the user from the which first data item or data defining access to a data item was received in dependence on the difference between the times and/or dates.

23. A system according to claim 15, wherein the changing step further comprises monitoring the time since the receipt of a data item or data defining access to a data item, and changing the service level data of the user from which the data item or data defining access to the data item was received in dependence on the monitored time.

24. A system according to claim 15, wherein the processor is further arranged to perform the following steps:—permit a user to perform manipulations of the stored content items or data defining access to content items in dependence on the user's service level data.

25. A system according to claim 14, collectively embodied by at least a sub-set of peers within a peer to peer network.

26. A system according to claim 15, wherein the rating is weighted according to the service level value of the rating user.

27. A data provisioning method, comprising the steps:
storing data items or data defining access to data items for provision to users;
maintaining, for one or more users, respective service level data usable to determine a level of service to be provided to the respective users;
receiving data items or data defining access to data items from users for provision to users;
receiving rating data from one or more users relating to data items provided to those users;
changing the respective service level data for those users from which data items or data defining access to data items were received in dependence upon received rating data relating to those received data items or data defining access to data items; and
providing service to a user in dependence on the service level data for that user,
wherein each data item or set of data defining access to a data item has a property having a value, and the service level data comprises a content access value relating to the property, wherein the servicing step comprises determining a sub-set of the data items or data defining access to data items in dependence on the respective values, and providing the sub-set to the requesting user.
